(19) United States
(12) Patent Application Publication
(10) Pub. No.: US 2014/0251643 A1
(43) Pub. Date: Sep. 11, 2014

(54) DEVICE FOR INTRODUCING AN AGENT INTO A FIRE SUPPRESSION SYSTEM

(71) Applicants: Brian J. Stumm, Helsinki (FI); Stephanie C. Thomas, Milford, MA (US)

(72) Inventors: Brian J. Stumm, Helsinki (FI); Stephanie C. Thomas, Milford, MA (US)

(73) Assignee: UTC FIRE & SECURITY CORPORATION, Farmington, CT (US)

(21) Appl. No.: 14/350,369

(22) PCT Filed: Oct. 13, 2011
(86) PCT No.: PCT/US2011/056128

§ 371 Date: Apr. 8, 2014

(51) Int. Cl. A62C 35/68; A62C 35/62

(52) U.S. Cl. CPC A62C 35/68; A62C 35/62
USPC 169/15; 169/19

(57) ABSTRACT

An exemplary device for introducing an agent into a fire suppression fluid includes a housing having an inlet configured to receive the agent into the housing. The housing also has an outlet configured to release the agent from the housing. A stopper is moveable between a closed position where the stopper prevents passage from the inlet to the outlet and an open position where the inlet is in communication with the outlet. A vane causes movement of the stopper from the closed position to the open position responsive to contact between the vane and fire suppression fluid flowing past the vane.

### BACKGROUND

Various fire suppression systems are known. Some are referred to as deluge systems because of the large amount of water that is introduced into an area to suppress or extinguish a fire. Other systems utilize sprinklers for spraying water into an area where fire protection is needed. Still others are referred to as mist systems because the sprinkler heads introduce a fine mist for suppressing or extinguishing a fire.

In some situations, a fire suppression system may be subject to freezing temperatures. In many instances, water is the primary fire suppression fluid and it is desirable to avoid freezing water within a fire suppression system for obvious reasons. One solution has been to include a freezing point depressant (e.g., antifreeze) within the fire suppression system. There are challenges associated with using a freezing point depressant in a fire suppression system.

One difficulty associated with using some commercially available freezing point depressants is that they tend to be corrosive. The presence of antifreeze in a water storage tank, for example, may introduce concerns regarding corrosion of the storage tank. The same concern arises when antifreeze is kept in pipes of the fire suppression system. Additionally, pumps used for fire suppression systems need to have corrosion protection when those pumps are exposed to antifreeze.

It is also difficult to ensure that the proper amount of freezing point depressant is introduced into the system. There are issues associated with having too much on the one hand and issues associated with having too little on the other hand.

### SUMMARY

An exemplary device for introducing an agent into a fire suppression fluid includes a housing having an inlet configured to receive the agent into the housing. The housing also has an outlet configured to release the agent from the housing. A stopper is moveable between a closed position where the stopper prevents passage from the inlet to the outlet and an open position where the inlet is in communication with the outlet. A vane causes movement of the stopper from the closed position to the open position responsive to contact between the vane and fire suppression fluid flowing past the vane.

An exemplary fire suppression system includes a pipe configured to carry a fire suppression fluid. At least one sprinkler is connected to the pipe to disburse the fire suppression fluid. There is a source of an agent to be introduced into the fire suppression fluid. A housing has an inlet coupled with the source to receive the agent from the source into the housing. The housing has an outlet configured to release the agent into the pipe. A stopper is moveable between a closed position where the stopper prevents the agent from passing through the outlet into the pipe and an open position where the agent is allowed to pass through the outlet into the pipe. A vane causes movement of the stopper from the closed position to the open position responsive to contact between the vane and fire suppression fluid flowing through the pipe.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an example fire suppression system designed according to an embodiment of this invention.

FIG. 2 is a cross-sectional illustration of an example device for introducing an agent into a fire suppression system designed according to an embodiment of this invention.

### DETAILED DESCRIPTION

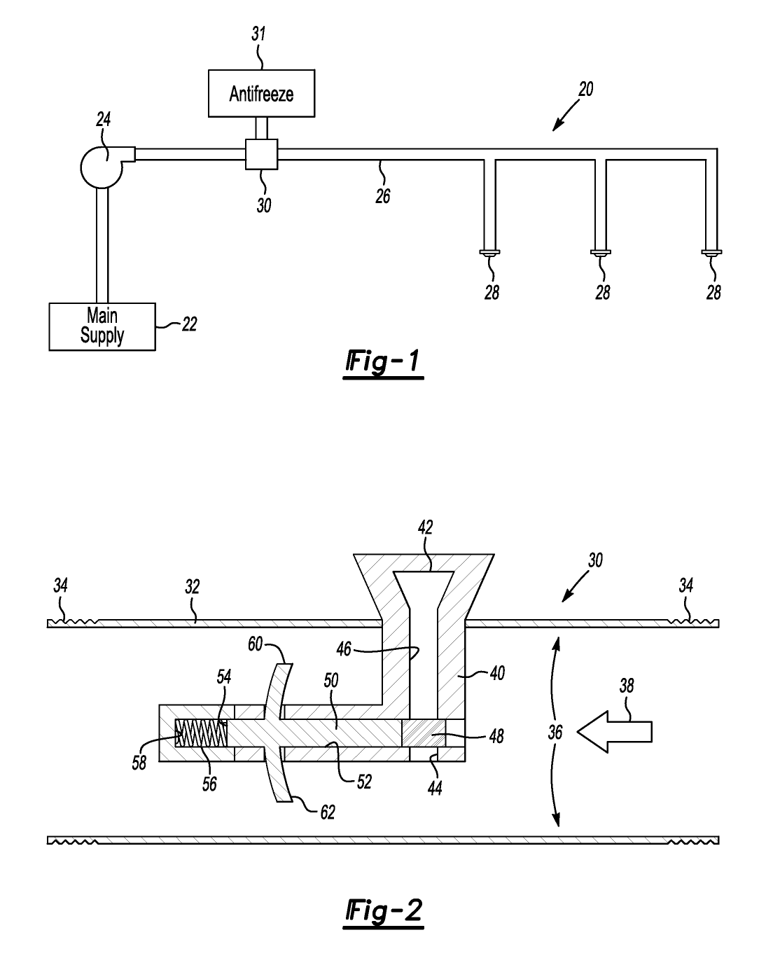

FIG. 1 schematically shows selected portions of a fire suppression system 20. Fire suppression fluid is provided by a main supply 22. In one example, the fire suppression fluid comprises water. The main supply 22 may be a storage tank or a municipal water supply, for example. A pump 24 facilitates introducing the fire suppression fluid at a sufficient pressure into a pipe network 26. A plurality of sprinklers 28 are arranged to introduce the fire suppression fluid into an area where protection against fire is desired. The sprinklers 28 in one example are configured to introduce a fine mist into the area where protection is desired.

A device 30 is associated with the pipe network 26 downstream of the pump 24 and the supply 22. The device 30 is configured to introduce an agent into the fire suppression fluid. In one example, the agent comprises a freezing point depressant that is stored in a container 31. In one example, the agent within the container 31 is the commercially available AQUAGREEN™ XT™ antifreeze. Other agents may be useful within the fire suppression system 20 and the device 30 can be used for introducing such agents to meet the needs of a particular situation. Given this description, those skilled in the art will realize how the example device 30 can be used for mixing in or introducing one or more agents into a fire suppression fluid.

FIG. 2 shows an example configuration of the device 30. This example includes a conduit connector portion 32 having ends 34 that are configured to be coupled with at least one of the pipes of the pipe network 26 of the fire suppression system 20. The illustrated example includes threaded ends for making a connection with a correspondingly threaded component of the pipe network 26.

The conduit connector portion 32 establishes a flow passage 36 for receiving fire suppression fluid. When associated with the pipe network 26, the fire suppression fluid flows through the flow passage 36 in a flow direction 38. This direction is the flow direction toward the sprinkler heads. In other words, the device 30 is upstream of the sprinklers 28. In situations in which it is desirable to avoid exposing the pump 24 to the agent, the flow direction 38 is downstream of the pump 26.

The device 30 includes a housing 40 having an inlet 42 that is configured to be connected with the storage container 31 of the agent to be introduced into the fire suppression fluid. The housing 40 also includes an outlet 44 that is situated for introducing the agent into the flow passage 36. A first portion of the housing 40 defines a passage 46 between the inlet 42 and the outlet 44.

A stopper 48 selectively closes off or opens up the passage 46 so that the agent (e.g., antifreeze) may flow into the inlet 42 of the housing 40 and out of the outlet 44 where the agent is introduced into the fire suppression fluid flowing through the flow passage 38.

In the illustrated example, the stopper 48 comprises a seal and is supported on a pin 50. The housing 40 includes a pin-receiving passage 52 to allow the pin to be slideable within the housing 40. One end 54 of the pin 50 is received against a biasing member 56 that urges the pin 50 into a position where the stopper 48 closes off the passage 46. In other words, the biasing member 56 biases the stopper member 48 into a closed position where the stopper prevents fluid passage from the inlet 42 to the outlet 44. In the illustrated example, the biasing member 56 comprises a spring that reacts against the end 54 of the pin 50 and a surface 58 within the housing 40.

A vane 60 is supported on the pin 50 so that at least a portion of the vane 60 is positioned outside of the housing 40. The vane 60 is oriented to move responsive to fire suppression fluid flowing through the passage 36 in the flow direction 38, which is parallel to an axis of the pin 50. The vane 60 in this example includes a concave surface 62 facing upstream so that the fire suppression fluid flowing through the passage 36 contacts the concave surface 62. In one example the vane 60 is annular.

The flowing fire suppression fluid urges the vane 60, the pin 50 and the stopper 48 to move in the same direction as the flow direction 38 against the bias of the biasing member 56. The flow of the fire suppression fluid urges the stopper 48 into an open position where the agent in the container 31 is allowed to pass from the inlet 42 through the passage 46 and out of the outlet 44. In other words, contact between the vane 60 and fire suppression fluid flowing through the passage 36 causes movement of the stopper 48 from the closed position into an open position.

In the illustrated example, the housing 40 first portion, which includes the passage 46, is oriented generally perpendicular to the direction of flow 38. A second portion of the housing, which supports the pin 50, the biasing member 56 and the vane 60 is oriented parallel to the direction of flow to allow the pin 50 to move in a direction parallel to its axis responsive to contact between fluid flowing through the passage 36 and the vane 60.

The illustrated example allows for introducing an agent into fluid flowing through the passage 36 and the pipe network 26. The illustrated example utilizes flowing fire suppression fluid for instigating the introduction of antifreeze or another agent into that fluid. Contact between the flowing fluid and the vane 60 causes the stopper 48 to move into the open position so that the agent may be introduced into the flowing fluid. When there is no fluid flowing through the passage 36, the biasing member 56 urges the stopper 48 into the closed position so that no antifreeze or other agent from the container 31 can be introduced into the fire suppression system 20.

The illustrated example device allows for selectively controlling when an agent is introduced into a fire suppression system. One feature of such a device is that it allows for using formulations at selected points in a system even though those formulations may not be compatible with upstream materials. Another feature is the ability to utilize a reduced amount of an agent because it can be selectively introduced only where most desired or needed. The illustrated example also provides control over the amount of an agent within the fire suppression fluid.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for introducing an agent into a fire suppression fluid, comprising:
a housing having an inlet configured to receive the agent into the housing and an outlet configured to release the agent from the housing;
a stopper that is moveable between a closed position where the stopper prevents passage from the inlet to the outlet and an open position where the inlet is in communication with the outlet; and
a vane that causes movement of the stopper from the closed position to the open position responsive to contact between the vane and fire suppression fluid flowing past the vane.

2. The device of claim 1, comprising
a biasing member that biases the stopper into the closed position and wherein the movement of the vane overcomes the bias of the biasing member to cause movement of the stopper into the open position.

3. The device of claim 2, wherein the biasing member comprises a spring.

4. The device of claim 2, wherein
the stopper comprises a pin and the biasing member applies a biasing force near one end of the pin in a direction along an axis of the pin.

5. The device of claim 1, wherein
the stopper comprises a pin that is supported in the housing to be moveable in a direction along an axis of the pin; and
the vane is connected with the pin and oriented to move responsive to fire suppression fluid flowing a direction parallel to the axis of the pin.

6. The device of claim 1, wherein the vane is at least partially outside of the housing.

7. The device of claim 1, wherein the vane is annular and has a concave surface facing a direction of flow of the fire suppression fluid.

8. The device of claim 1, wherein
the housing has a first portion defining a passage between the inlet and the outlet and a second portion that supports a portion of the stopper and the vane and
the second portion is generally perpendicular to the first portion.

9. The device of claim 8, comprising
a conduit connector portion defining a flow passage for receiving fire suppression fluid, the flow passage having a direction of flow and
wherein the second portion is at least partially within the flow passage and aligned parallel to the direction of flow.

10. The device of claim 9, wherein the first and second portions are within the flow passage.

11. The device of claim 1, wherein the agent comprises a freezing point depressant.

12. A fire suppression system, comprising:
a pipe configured to carry a fire suppression fluid;
at least one sprinkler connected to the pipe to disperse the fire suppression fluid;
a source of an agent to be introduced into the fire suppression fluid;
a housing having an inlet coupled with the source to receive the agent from the source into the housing, the housing having an outlet configured to release the agent into the pipe;
a stopper that is moveable between a closed position where the stopper prevents the agent from passing through the outlet into the pipe and an open position where the agent is allowed to pass through the outlet into the pipe; and
a vane that causes movement of the stopper from the closed position to the open position responsive to contact between the vane and fire suppression fluid flowing through the pipe.

13. The system of claim 12, comprising
a biasing member that biases the stopper into the closed position and wherein the fluid flowing through the pipe has sufficient pressure to overcome the bias of the biasing member to cause movement of the vane and corresponding movement of the stopper into the open position.

14. The system of claim 13, wherein
the stopper comprises a pin and the biasing member applies a biasing force near one end of the pin in a direction along an axis of the pin;
the stopper is supported in the housing to be moveable in a direction along an axis of the pin;
the vane is connected with the pin; and
the axis of the pin is oriented parallel to the direction of fluid flowing through the pipe.

15. The system of claim 12, wherein the vane is at least partially outside of the housing.

16. The system of claim 12, wherein the vane is annular and has a concave surface facing a direction of flow of the fire suppression fluid.

17. The system of claim 12, wherein
the housing has a first portion defining a passage between the inlet and the outlet and a second portion that supports a portion of the stopper,
the second portion is generally perpendicular to the first portion, and
the second portion is aligned parallel to a direction of fire suppression fluid flow through the pipe.

18. The system of claim 17, wherein the pipe comprises a first portion and a second portion and comprising
a conduit connector portion between the first and second portions of the pipe, the conduit connector portion defining a flow passage for receiving fire suppression fluid flowing in a direction from the first portion toward the second portion and
wherein the second portion is at least partially within the conduit connector portion.

19. The system of claim 18, wherein the first and second portions are within the conduit connector portion.

20. The system of claim 12, wherein the agent comprises a freezing point depressant.
